(19) United States
(12) Patent Application Publication
(10) Pub. No.: US 2016/0076441 A1
(43) Pub. Date: Mar. 17, 2016

(54) COMPACT NON-VIBRATING ENDOTHERMIC ENGINE

(71) Applicant: Pierfrancesco PONIZ, Mestre (VE) (IT)

(72) Inventor: Pierfrancesco Poniz, Mestre (VE) (IT)

(21) Appl. No.: 14/785,842

(22) PCT Filed: Mar. 17, 2014
(86) PCT No.: PCT/IB2014/059895

§ 371 Date: Oct. 20, 2015

(30) Foreign Application Priority Data
Apr. 22, 2013 (IT) VE2013A000020

(51) Int. Cl. F02B 75/28; F02B 75/02

(52) U.S. Cl. CPC F02B 75/28; F02B 75/02; F02B 2075/025

(57) ABSTRACT

The Compact Non Vibrating Endothermic Engine (CoNVEE in the following) is an internal combustion engine with reciprocating motion of the pistons, whose innovative architecture makes it more compact, given the same delivered power, with respect to the current state of the art. This happens both because the CoNVEE core occupies a very reduced volume, and also because it does not require the presence of any additional compensation or damping of mechanical vibrations. In fact all the moving parts of the CoNVEE are already internally compensated: they act in perfect anti-symmetry compensating each inertia force developed, excluding, of course, that of the motor shaft which is indispensable for the generation of the useful mechanical energy. The intrinsic compactness of the CoNVEE is made possible by the new and characteristic mechanism adopted for the motion transfer from the pistons to the motor shaft. The CoNVEE may be conveniently used with any type of propulsion fuel and, particularly, for those applications which require high power density and low vibration in the motor.

### RELATED APPLICATIONS

This application is the U.S. National Stage under 35 USC 371 of PCT Application PCT/IB2014/059895.and claims foreign priority based of Italian patent application VE2013A000020.

### BACKGROUND OF THE INVENTION

### Field of the Invention

The “Compact Non-vibrating Endothermic Engine” (in the following “CoNVEE”) is an internal combustion engine with reciprocating motion of two pistons inside one cylinder; said “CoNVEE” is a two-stroke engine with unidirectional scavenging of the combustion chamber.

### SUMMARY OF THE INVENTION

A fundamental innovation that characterizes said “CoNVEE” is the mechanism for the transformation of the axial reciprocating motion of the pistons into rotational motion of the motor shaft. Said mechanism comprises the following three basic parts.

### DETAILED DESCRIPTION OF THE PREFERRED EMBODIMENTS

1. A piece here named “T-rod” connected to each piston: said “T-rod” comprises a cylindrical stem which is rigidly attached to the center of the piston at one end, and two equal arms which are rigidly attached on the other end of said cylindrical stem; said two equal arms fork in opposite direction and terminate with a certain type of tappet or roller. In a possible realization, said two arms are aligned each other and they are both perpendicular to said cylindrical stem: said cylindrical stem and said two equal arms thus form a piece shaped as a “T”. 2. A hollow cylindrical cam (thus an axial section of said hollow cylindrical cam has the shape of a circular crown); the driving profile of said hollow cylindrical cam is facing the inside of the central cavity and it may have an optimized shape, not necessarily sinusoidal, to prevent jamming and to best exploit the thrust of the piston, and said driving profile is twice identically replicated along the complete round angle.

3. An element here named “T-rod guidance”, which is integral with the frame, is positioned at each end of the cylinder and it is thus located inside the central cavity of the cylindrical cam; said “T-rod guidance” element allows the sliding of said “T-rod” in the axial direction only, tying said its arms in order to prevent the rotation of the “T-rod” around its oscillating movement's axis.

An axial bearing is applied on the frame (a roller bearing or another type of bearing or, however, an element that constitutes an ideally nonstick interface). The cylindrical cam can slide by rotating around its axis over said axial bearing. The two arms of said “T-rod” are inserted into the “T-rod guidance” and their ends are hooked on the driving profile of the cylindrical cam. The movement of the piston, aroused by the thermodynamic cycle that takes place in the cylinder, makes said arms of the “T-rod” to slide along said “T-rod guidance” with a purely axial reciprocating movement; the ends of said arms will act as a tappet on the driving profile of the cylindrical cam that will draw a movement of pure rotation around its axis. Due to the action of said “T-rod guidance” on said “T-rod”, the torque that moves the cam neither causes any rotation of said T-rod arms nor of the piston.

This mechanism, just described above, is characterized by the fact that it allows the transformation of the purely axial movement of the piston into rotational movement of the cylindrical cam around the same axis of oscillation of the piston. This mechanism has very few moving parts: just the “T-rod” rigidly attached to the piston and the cylindrical cam coupled through an axial bearing to the frame of the engine.

Differently from the classic rod-crank systems which are today widely used, the mechanism described in this invention does not raise any slap on the piston, whose skirt can therefore be significantly reduced, for example, the height of the piston may be smaller than the radius of the piston itself, thus obtaining great advantages due to the reduction in size which may be achieved.

The fact that the stem of said “T-rod” has a cylindrical section and its motion is purely axial, makes easier to achieve a pre- compression chamber in which a wall closes the cylinder on the back of the piston (and it is therefore crossed by said stem of said “T-rod”); the engine may thus exploit the second effect (otherwise called back stroke) of the piston to push the fresh input charge in the cylinder (it may arrive there via some nonreturn valves, strips or the like): this is also the best implementation for the scavenging of the cylinder in two-stroke cycle engines.

For this reason said “CoNVEE” uses a particular two-stroke cycle, with unidirectional scavenging of the combustion chamber: this type of scavenging is the most effective, but it requires two opposing pistons in the cylinder (not wanting to use poppet valves) and, until today, it was mostly implemented using two crankshafts at the ends of the cylinder.

Thanks to the mechanism described in this invention, said “CoNVEE” neither need an external blower for scavenging of the combustion chamber (saving the associated encumbrance) nor the couple of shafts at the ends of the cylinder: two pistons, each with its related mechanisms according with this invention, are at the ends of the cylinder, and a single straight shaft, more thin of a crankshaft because stressed only to torsion, is placed nearby parallel to the cylinder axis; said shaft also acts as a synchronization shaft (via gear trains or the like) for the movement of the cylindrical cams.

The opposition of the two mechanisms according to the invention, operating in synchrony at the ends of the cylinder, balances the internal oscillating inertia: nevertheless the rotating inertia of cylindrical cams (also gyroscopic effects in the case of movements of the entire engine) remains unbalanced and pulsating due to the thrust deriving from combustion. These last inconveniences may be managed in said “CoNVEE” by placing, side by side, two parallel and equal cylinders, each cylinder having two cylindrical cams rotating in the opposite direction; the two mechanisms of the two cylinders may be directly meshed or synchronized each other through gear trains or the like. In one possible different implementation two cylinders may have their thermodynamic cycle phase shifted by half a period so as to increase the continuity of motion, limiting the need for flywheel in addition to that already constituted by the cylindrical cams.

Given the same dimensions, it is therefore evident that said “CoNVEE”, according to the teachings of the present invention, has a greater power density than any internal combustion engine up to now used in any kind of the prior art applications. Said “CoNVEE” also presents a greater simplicity of construction since it requires a lower number of moving parts, whose motion is moreover intrinsically balanced.

### BRIEF DESCRIPTION OF THE DRAWINGS

The Figures attached to this description represent an extract of a design of a potentially real implementation of a “CoNVEE” according to the teachings of the invention.

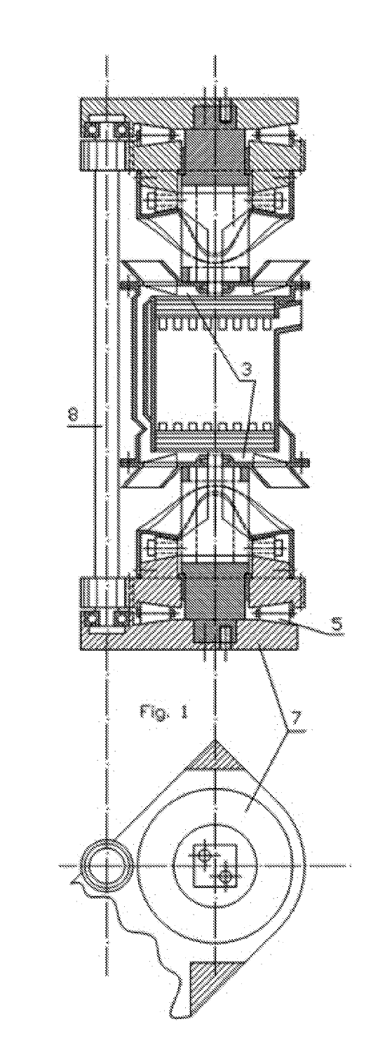

The above part of “FIG. 1 ” shows front view, i.e. the axial development, of a cylinder of said “CoNVEE” flanked by the motor shaft, while the part below of the same “FIG. 1 ” shows the plant view of the portion of the frame that supports them.

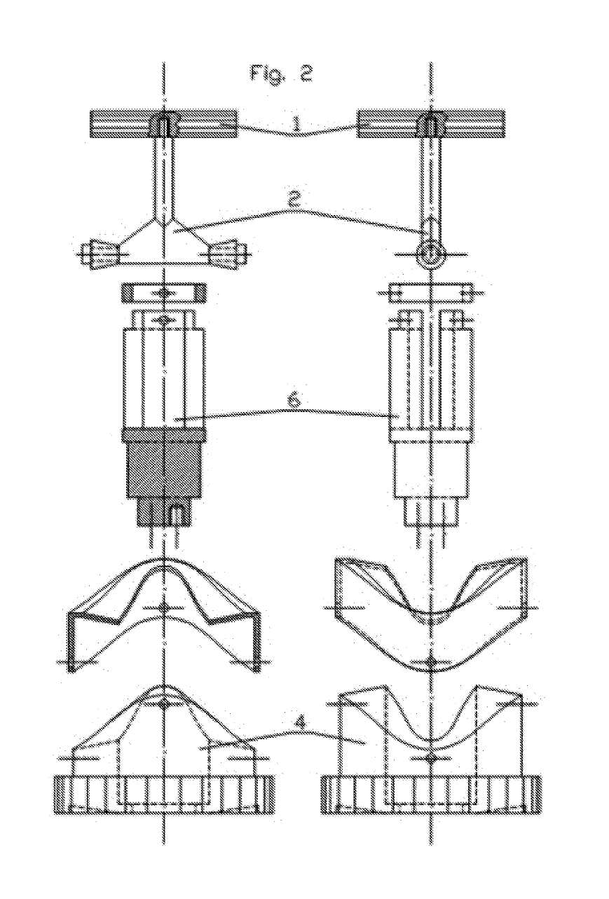

“FIG. 2” shows the two orthogonal section views (the front and the side, along the axis of the cylinder) of the fundamental parts of said cylinder.

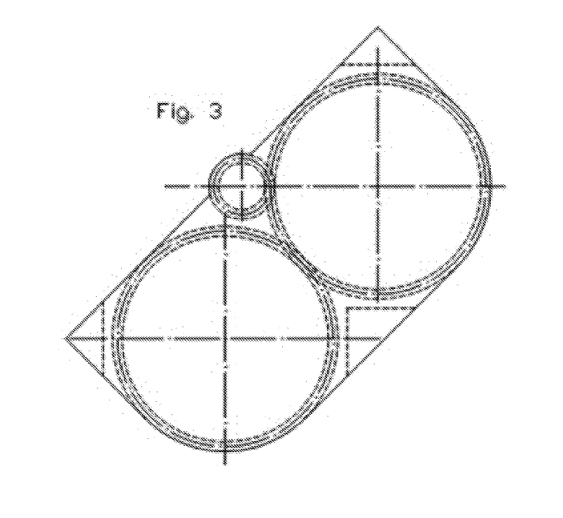

“FIG. 3” shows the view of the footprint of the two cylinders “CoNVEE”.

Any construction detail outlined in the drawings and not explicitly described here is present with the purpose to provide an example of a possible assembly of the machine described; said details outlined in the drawings but not described above as essential characteristics of the invention are not binding on the implementation of a “CoNVEE” according to the present invention. It is therefore clear that further variants can be made by those experts in the field without departing from the scope of the invention as it is claimed in the following. List of items drawn:

1. Piston

2. “T-Rod”

3. Pre-compression Chamber

4. Cylindrical Cam

5. Axial Bearing

6. “T-Rod Guidance”

7. Frame

8. Motor Shaft/Synchronization Shaft

1. An internal combustion two-strokes engine comprising at least one cylinder with two pistons inside, facing each other
said two pistons have, having an axial reciprocating motion, and characterized in that:
when said two pistons move towards the ends of the cylinder, each of said two pistons pushes towards outside the cylinder a “T-rod”,
each of said two “T-rods” comprises a stem parallel to the direction of motion of said two pistons and two arms;
said stem is fixed, on one end, to the piston's back and, on the other end, it is fixed to said two arms that fork in opposite directions and said two arms are terminated with tappets or rollers;
the movement of said stem of said “T-rod”, referred to the frame of said engine, is purely axial along its axis without any rotation and said stem slides across a hole obtained in the wall that closes the end of said cylinder, to achieve a pre-compression chamber;
said internal combustion two-strokes engine, at each end of each cylinder has a “T-rod guidance” element which is fixed to the frame of the engine, and said “T-rod guidance” binds said arms of the “T-rod”, so that said “T-rod” and said relative fixed piston can slide along the axial direction of the cylinder housing said piston, being prevented by said guidance to spin around said cylinder's axis;
said internal combustion two-strokes engine comprises also a hollow cylindrical cam associated to each piston;
a straight motor shaft is coupled via gear trains, or other similar mechanisms to said two hollow cylindrical cams for the transfer of the motion, and its axis is parallel to the axis of said cylinder.

2. (canceled)

3. An internal combustion two-strokes engine according to claim 1 wherein said each two hollow cylindrical cams associated to each cylinder contain said “T-rod guidance” element inside their cavity,
and wherein said axis of said cylinder coincides with the axis of rotation of said two hollow cylindrical cams_{;}
and wherein said two hollow cylindrical cams are associated with the two pistons contained in said cylinder by means of said arms of said “T-rods” which act on the driving profiles of said two cylindrical cams via tappets or rollers; and wherein said two hollow cylindrical cams are bound to the frame so that they can only rotate around their axis.

4. An internal combustion two-strokes engine according to claim 2 wherein said driving profile of said hollow cylindrical cams have a shape repeated twice around the whole circumference of each hollow cylindrical cam.

5. An internal combustion two-strokes engine according to claim 1 wherein said piston has a skirt that is short enough to keep the piston's height shorter than the piston's radius.

6. (canceled)

7. An internal combustion two-strokes engine according to claim 1 wherein said straight motor shaft is coupled to at least two cylinders.

8. An internal combustion two-strokes engine according to claim 1 wherein said straight motor shaft, which receives its motion from said cylindrical cams, serves also as a synchronization shaft between the two cylindrical cams associated to each cylinder of said internal combustion two-strokes engine.

9. An internal combustion two-strokes engine according to claim 1 wherein each pair of said hollow cylindrical cams, associate to one cylinder, shares its motion with another pair of cylindrical cams associated to another cylinder, and said two pairs of cylindrical cams are directly meshed or synchronized each other through gear trains, or other similar mechanisms for the transfer of the motion.

10. An internal combustion two-strokes engine according to claim 3 wherein said hollow cylindrical cams which bear the motion to the shaft have smaller cross section's inner diameter compared to the cylinder's cross section diameter.
